(19) United States
(12) Patent Application Publication
(10) Pub. No.: US 2024/0323838 A1
(43) Pub. Date: Sep. 26, 2024

(54) TECHNIQUES FOR UPLINK AND DOWNLINK MEASUREMENT MANAGEMENT FOR LOW POWER COMMUNICATING NETWORKS AND USER EQUIPMENTS

(71) Applicant: QUALCOMM Incorporated, San Diego, CA (US)

(72) Inventors: Ahmed Elshafie, San Diego, CA (US); Krishna Kiran Mukkavilli, San Diego, CA (US); Marwen Zorgui, San Diego, CA (US); Diana Maamari, San Diego, CA (US); Ahmed Attia Abotabl, San Diego, CA (US)

(21) Appl. No.: 18/189,150

(22) Filed: Mar. 23, 2023

(51) Int. Cl. H04W 52/02; H04W 24/08

(52) U.S. Cl. CPC H04W 52/0216; H04W 24/08

(57) ABSTRACT

Methods, systems, and devices for wireless communications are described. Radio resource management (RRM) signals for a RRM procedure may be adjusted for a user equipment (UE) or a cell operating in a low power mode, such as by relaxing, canceling, or prioritizing some RRM signals with respect to other signals based on power conditions at the UE or the cell. A UE may receive, from a network entity, scheduling information for a set of RRM signals. The UE may identify a first power condition at the UE and select a subset of the set of RRM signals based on the first power condition at the UE and/or a second power condition at the network entity. The UE may communicate, with the network entity, the subset of the set of RRM signals.

### FIELD OF DISCLOSURE

The present disclosure, for example, relates to wireless communication systems, more particularly to techniques for uplink and downlink measurement management for low power communicating networks and user equipments.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The present disclosure relate to improved methods, systems, devices, and apparatuses that support uplink and downlink measurement management for low power communicating networks and user equipments (UEs). For example, the present disclosure provide for adjusting radio resource management (RRM) signals based on low power conditions at a UE or network entity. One or more scheduled RRM signals may be adjusted to accommodate a UE or a cell (e.g., network entity) that is in the low power mode, such as by relaxing, canceling, or prioritizing the one or more RRM signals with respect to other RRM signals based on power conditions at the UE or the cell.

A method for wireless communications at a UE is described. The method may include receiving, from a network entity, control signaling scheduling a set of RRM signals, identifying a first power condition at the UE, selecting a subset of the set of RRM signals based on the identified first power condition at the UE, a second power condition at the network entity, or a combination thereof, and communicating, with the network entity, the subset of the set of RRM signals.

An apparatus for wireless communications at a UE is described. The apparatus may include a processor, memory coupled with the processor, and instructions stored in the memory. The instructions may be executable by the processor to cause the apparatus to receive, from a network entity, control signaling scheduling a set of RRM signals, identify a first power condition at the UE, select a subset of the set of RRM signals based on the identified first power condition at the UE, a second power condition at the network entity, or a combination thereof, and communicating, with the network entity, the subset of the set of RRM signals.

Another apparatus for wireless communications at a UE is described. The apparatus may include means for receiving, from a network entity, control signaling scheduling a set of RRM signals, means for identifying a first power condition at the UE, means for selecting a subset of the set of RRM signals based on the identified first power condition at the UE, a second power condition at the network entity, or a combination thereof, and means for communicating, with the network entity, the subset of the set of RRM signals.

A non-transitory computer-readable medium storing code for wireless communications at a UE is described. The code may include instructions executable by a processor to receive, from a network entity, control signaling scheduling a set of RRM signals, identify a first power condition at the UE, select a subset of the set of RRM signals based on the identified first power condition at the UE, a second power condition at the network entity, or a combination thereof, and communicating, with the network entity, the subset of the set of RRM signals.

In some examples of the method, apparatuses, and non-transitory computer-readable medium described herein, selecting the subset of the set of RRM signals may include operations, features, means, or instructions for canceling at least one of the set of RRM signals.

In some examples of the method, apparatuses, and non-transitory computer-readable medium described herein, selecting the subset of the set of RRM signals may include operations, features, means, or instructions for selecting the subset of the set of RRM signals in accordance with a pattern.

Some examples of the method, apparatuses, and non-transitory computer-readable medium described herein may further include operations, features, means, or instructions for receiving control signaling indicating a configuration for selecting the subset of the set of RRM signals when the first power condition or the second power condition occurs.

In some examples of the method, apparatuses, and non-transitory computer-readable medium described herein, selecting the subset of the set of RRM signals may include operations, features, means, or instructions for canceling a RRM signal of the set of RRM signals based on a first priority of the RRM signal being less than a second priority of a signal that overlaps with the RRM signal.

In some examples of the method, apparatuses, and non-transitory computer-readable medium described herein, selecting the subset of may include operations, features, means, or instructions for increasing a priority of a RRM signal of the set of RRM signals based on canceling a prior RRM signal of the set of RRM signals.

Some examples of the method, apparatuses, and non-transitory computer-readable medium described herein may further include operations, features, means, or instructions for canceling a signal that overlaps with the RRM signal based on the increased priority of the RRM signal.

In some examples of the method, apparatuses, and non-transitory computer-readable medium described herein, communicating the subset of the set of RRM signals may include operations, features, means, or instructions for transmitting a subset of the set of sounding reference signals.

In some examples of the method, apparatuses, and non-transitory computer-readable medium described herein, communicating the subset of the set of RRM signals may include operations, features, means, or instructions for receiving a subset of the set of synchronization signal blocks (SSBs).

Some examples of the method, apparatuses, and non-transitory computer-readable medium described herein may further include operations, features, means, or instructions for performing RRM measurements on the subset of the set of SSBs.

Some examples of the method, apparatuses, and non-transitory computer-readable medium described herein may further include operations, features, means, or instructions for receiving a signal transmitted via a wake-up radio of the network entity, where reception of the signal indicates the second power condition.

Some examples of the method, apparatuses, and non-transitory computer-readable medium described herein may further include operations, features, means, or instructions for identifying the first power condition may be based on use of a wake-up radio at the UE.

Some examples of the method, apparatuses, and non-transitory computer-readable medium described herein may further include operations, features, means, or instructions for receiving an indication of a low power state or the second power condition at the network entity.

In some examples of the method, apparatuses, and non-transitory computer-readable medium described herein, the identified first power condition includes the UE being at a cell edge.

A method for wireless communications at a network entity is described. The method may include transmitting, to a UE, control signaling scheduling a set of RRM signals, identifying a second power condition at the network entity, selecting a subset of the set of RRM signals based on a first power condition at the UE, the identified second power condition at the network entity, or a combination thereof, and communicating, with the UE, the subset of the set of RRM signals.

An apparatus for wireless communications at a network entity is described. The apparatus may include a processor, memory coupled with the processor, and instructions stored in the memory. The instructions may be executable by the processor to cause the apparatus to transmit, to a UE, control signaling scheduling a set of RRM signals, identify a second power condition at the network entity, select a subset of the set of RRM signals based on a first power condition at the UE, the identified second power condition at the network entity, or a combination thereof, and communicating, with the UE, the subset of the set of RRM signals.

Another apparatus for wireless communications at a network entity is described. The apparatus may include means for transmitting, to a UE, control signaling scheduling a set of RRM signals, means for identifying a second power condition at the network entity, means for selecting a subset of the set of RRM signals based on a first power condition at the UE, the identified second power condition at the network entity, or a combination thereof, and means for communicating, with the UE, the subset of the set of RRM signals.

A non-transitory computer-readable medium storing code for wireless communications at a network entity is described. The code may include instructions executable by a processor to transmit, to a UE, control signaling scheduling a set of RRM signals, identify a second power condition at the network entity, select a subset of the set of RRM signals based on a first power condition at the UE, the identified second power condition at the network entity, or a combination thereof, and communicating, with the UE, the subset of the set of RRM signals.

In some examples of the method, apparatuses, and non-transitory computer-readable medium described herein, selecting the subset of the set of RRM signals may include operations, features, means, or instructions for canceling at least one of the set of RRM signals.

Some examples of the method, apparatuses, and non-transitory computer-readable medium described herein may further include operations, features, means, or instructions for performing RRM measurements on the subset of the set of sounding reference signals.

In some examples of the method, apparatuses, and non-transitory computer-readable medium described herein, selecting the subset of the set of RRM signals may include operations, features, means, or instructions for selecting the subset of the set of RRM signals in accordance with a pattern.

Some examples of the method, apparatuses, and non-transitory computer-readable medium described herein may further include operations, features, means, or instructions for transmitting, to the UE, control signaling indicating a configuration for selecting the subset of the set of RRM signals when the first power condition or the second power condition occurs.

In some examples of the method, apparatuses, and non-transitory computer-readable medium described herein, selecting the subset of the set of RRM signals may include operations, features, means, or instructions for canceling a RRM signal of the set of RRM signals based on a first priority of the set of RRM signals being less than a second priority of a signal that overlaps with the set of RRM signals.

In some examples of the method, apparatuses, and non-transitory computer-readable medium described herein, selecting the subset of the set of RRM signals may include operations, features, means, or instructions for increasing a priority of a RRM signal of the set of RRM signals based on canceling a prior RRM signal of the set of RRM signals.

Some examples of the method, apparatuses, and non-transitory computer-readable medium described herein may further include operations, features, means, or instructions for canceling a signal that overlaps with the RRM signal based on the increased priority of the RRM signal.

In some examples of the method, apparatuses, and non-transitory computer-readable medium described herein, communicating the subset of the set of RRM signals may include operations, features, means, or instructions for receiving a subset of the set of sounding reference signals.

In some examples of the method, apparatuses, and non-transitory computer-readable medium described herein, communicating the subset of the set of RRM signals may include operations, features, means, or instructions for transmitting the subset of the set of SSBs.

Some examples of the method, apparatuses, and non-transitory computer-readable medium described herein may further include operations, features, means, or instructions for transmitting a signal via a wake-up radio of the network entity, where identifying the second power condition may be based on transmission of the signal.

In some examples of the method, apparatuses, and non-transitory computer-readable medium described herein, the first power condition includes use of a wake-up radio at the UE.

Some examples of the method, apparatuses, and non-transitory computer-readable medium described herein may further include operations, features, means, or instructions for transmitting, to the UE, an indication of a low power state or the second power condition at the network entity.

### BRIEF DESCRIPTION OF THE DRAWINGS

FIG. 1 shows an example of a wireless communications system that supports uplink and downlink measurement management for low power communicating networks and user equipments (UEs) in accordance with various aspects of the present disclosure.

FIG. 2 shows an example of a block diagram of a UE that supports uplink and downlink measurement management for low power communicating networks and UEs in accordance with various aspects of the present disclosure.

FIG. 3 shows an example of a wireless communications system that supports uplink and downlink measurement management for low power communicating networks and UEs in accordance with various aspects of the present disclosure.

FIG. 4 shows an example of a process flow that supports uplink and downlink measurement management for low power communicating networks and UEs in accordance with various aspects of the present disclosure.

FIGS. 5 and 6 show block diagrams of devices that support uplink and downlink measurement management for low power communicating networks and UEs in accordance with various aspects of the present disclosure.

FIG. 7 shows a block diagram of a communications manager that supports uplink and downlink measurement management for low power communicating networks and UEs in accordance with various aspects of the present disclosure.

FIG. 8 shows a diagram of a system including a device that supports uplink and downlink measurement management for low power communicating networks and UEs in accordance with various aspects of the present disclosure.

FIGS. 9 and 10 show block diagrams of devices that support uplink and downlink measurement management for low power communicating networks and UEs in accordance with various aspects of the present disclosure.

FIG. 11 shows a block diagram of a communications manager that supports uplink and downlink measurement management for low power communicating networks and UEs in accordance with various aspects of the present disclosure.

FIG. 12 shows a diagram of a system including a device that supports uplink and downlink measurement management for low power communicating networks and UEs in accordance with various aspects of the present disclosure.

FIGS. 13 and 14 show flowcharts illustrating methods that support uplink and downlink measurement management for low power communicating networks and UEs in accordance with various aspects of the present disclosure.

### DETAILED DESCRIPTION

In wireless communications systems, a user equipment (UE) may communicate with a cell (e.g., a network entity). The cell may be inactive in a sleep mode, for example, to preserve power when there is no traffic between the cell and UEs or if the expected traffic is low. While in a sleep mode, the cell may periodically transmit signals to the UE (e.g., synchronization signal blocks (SSBs) or system information (SI)) or monitor for signals from the UE (e.g., random access channel (RACH) signals or small data transmissions (SDT)). The cell may enter an active mode in order to periodically transmit and monitor for such signaling. The UE may send a wake-up signal (WUS) to the cell indicating that transmission or monitoring is expected at the cell. The cell may switch from an inactive mode to an active mode based on the WUS. In some cases, the UE may be inactive in a sleep mode, for example, to preserve power at the UE. The UE or the cell may have a low power wake-up radio, which may activate a main radio of the UE or the cell. The low power wake-up radio may activate or not activate the main radio based on one or more traffic conditions at the UE or the cell. The UE or the cell may perform radio resource management (RRM) measurements for a RRM procedure to ensure efficient use of resources, such that uplink quality for transmitting signals from the UE to the cell and downlink quality for transmitting signals from the cell to the UE, is above a quality threshold. However, the RRM measurements at the UE or the cell may be power consuming and the UE or the cell may be in the low power mode.

One or more scheduled RRM signals may be adjusted to accommodate the UE or the network entity (e.g., the cell) being in a low power mode, such as by relaxing, canceling, or prioritizing the one or more RRM signals with respect to other signals based on power conditions at the UE or the network entity. Uplink RRM procedures may involve the UE transmitting SRSs to the network entity, and the network entity performing RRM measurements on the SRSs. Downlink RRM procedures may involve the network entity transmitting SSBs to the UE, and the UE performing RRM measurements on the SSBs. Power conditions for the UE that may trigger adjustment of RRM signals may include a low power state at the UE or at the network entity, low mobility (e.g., stationary), or being on a cell edge. Power conditions for the network entity that may trigger adjustment of RRM signals may include receiving or transmitting a signal from a wake-up radio of the network entity. Adjusting the RRM signals may facilitate the UE or the network entity to perform the RRM procedure while preserving power.

In some examples, adjusting the RRM signals may include canceling one or more RRM signals based on a priority of other signals, reprioritizing RRM signals (e.g., based on canceling other RRM signals), or selecting a subset of the RRM signals based on a predetermined pattern. Relaxing the RRM signals may include delaying, stopping, or increasing the interval between performing measurements.

Aspects of the disclosure are initially described in the context of wireless communications systems. Aspects of the disclosure are further illustrated by and described with reference to apparatus diagrams, system diagrams, and flowcharts that relate to uplink and downlink measurement management for low power communicating networks and UEs.

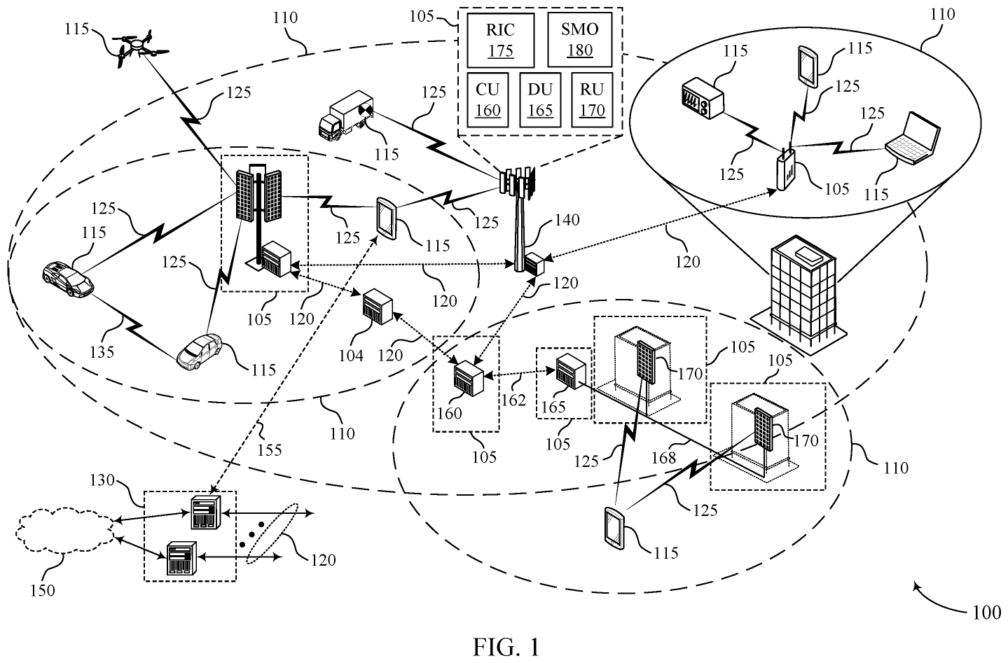

FIG. 1 shows an example of a wireless communications system 100 that supports uplink and downlink measurement management for low power communicating networks and UEs in accordance with various aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network. one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support uplink and downlink measurement management for low power communicating networks and UEs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell, for example, covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or some predetermined functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). For example, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), unlicensed radio frequency spectrum band technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along specific orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a specific orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a specific receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some UEs 115 include a wake-up radio receiver (e.g., a second radio) in addition to a main radio (e.g., a first radio). The wake-up radio may monitor for the WUS, reference signals (for channel estimation), or synchronization signals (for synchronization) while the UE 115 is in a sleep mode or a low power mode. The wake-up radio uses less power than the main radio, and accordingly inclusion of a wake-up radio saves power at the UE 115 when the UE 115 is in a sleep mode. The network entity 105 may include a wake-up radio receiver and a main radio, and may operate similarly.

The UE 115 and the network entity 105 may perform RRM measurements in RRM procedures to ensure efficient use of resources, such that uplink quality for transmitting signals from the UE 115 to the network entity 105 and downlink quality for transmitting signals from the network entity 105 to the UE 115 is above a quality threshold. However, the RRM measurements at the UE 115 and the network entity 105 may be power consuming and the UE 115 or the network entity 105 may be in a low power mode.

One or more scheduled RRM signals may be adjusted to accommodate the UE 115 or the network entity 105 (e.g., a cell) being in a low power mode, such as by relaxing, canceling, or prioritizing the one or more RRM signals with respect to other signals based on power conditions at the UE 115 or at the network entity 105. Uplink RRM procedures may involve the UE 115 transmitting SRSs to the network entity 105, and the network entity 105 performing RRM measurements on the SRSs. Downlink RRM procedures may involve the network entity 105 transmitting SSBs to the UE 115, and the UE 115 performing RRM measurements on the SSBs. Power conditions for the UE 115 that may trigger adjustment of the RRM signals may include a low power state at the UE 115 or at the network entity 105, low mobility (e.g., being stationary), or being on a cell edge. Power conditions for the network entity 105 that may trigger adjustment of RRM signals may include receiving or transmitting a signal from a wake-up radio of the network entity 105. Adjusting the RRM signals may facilitate the UE 115 or the network entity 105 to perform the RRM procedure while preserving power.

In some examples, adjusting the RRM signals may include canceling one or more RRM signals based on a priority of other RRM signals, reprioritizing RRM signals (e.g., based on canceling other RRM signals), or selecting a subset of the RRM signals based on a predetermined pattern. Relaxing the RRM signals may include delaying, stopping, or increasing the interval between performing measurements.

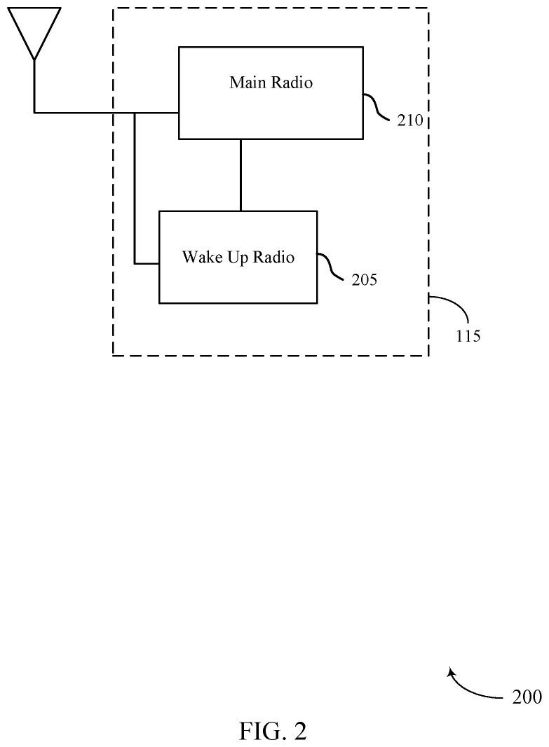

FIG. 2 shows an example of a block diagram 200 of a UE 115 that supports uplink and downlink measurement management for low power communicating networks and UEs 115 in accordance with various aspects of the present disclosure. The block diagram 200 may implement aspects of the wireless communications system 100. For example, the UE 115 a may be an example of a UE 115 as described herein.

In some cases, a network may consume energy to run a cellular network. Energy consumption may be a large amount of total network expenses (e.g., 23% total expense). Most network energy consumption may come from RAN (e.g., around 50% in 5G) and network energy savings features may be used for adoption and expansion of cellular networks. Energy savings features may include a wake-up radio in the network components, such as the UE 115 or the network entity 105.

For some durations, such as a time during the day (e.g., off-peak times), little to no traffic load may occur at a given network entity 105 (e.g., a cell). However, the network entity 105 may periodically transmit broadcast signal or channel (e.g., SSBs and SI), as well as periodically monitor physical random access channel (PRACH) occasions for possible RACH or SDT from the UE 115. This periodic transmission and periodic monitoring may cause the network entity 105 to be in an active mode. Accordingly, the network power consumption may be impacted without providing additional services (e.g., beyond broadcast signal transmission and monitoring). If the network entity 105 is aware that there are no connected UEs 115 or that there is light traffic load in the network entity 105, the network entity 105 may stop or reduce the periodic transmission and periodic monitoring for network power savings. However, the network entity 105 may be aware of whether one or more UEs 115 may enter a connected state or perform some SDT so that the network entity 105 may efficiently transition to the active mode. Such UEs 115 may proactively wake-up the network entity 105 by sending some physical layer signal (e.g., PRACH or SR). Although the following descriptions for FIG. 2 are discussed with respect to the UE 115, the techniques described herein for FIG. 2 may also apply to a network entity 105.

The UE 115 may include a wake-up radio 205 (e.g., a low power wake-up radio) in addition to a main radio 210. The wake-up radio 205 may be a companion receiver that monitors for WUSs with low power consumption while the main radio 210 is in a sleep mode (e.g., a deep sleep state). The wake-up radio 205 may be powered separately from the main radio 210 in order to consume less power than the main radio 210 (e.g., the wake-up radio 205 may use less power hungry blocks). The wake-up radio 205 may wake-up the main radio 210 when data communication is demanded. Inclusion of a wake-up radio 205 in a UE 115 may reduce total power consumption at the UE 115 by avoiding unnecessary wake-up of the main radio 210, which uses more power than the wake-up radio 205. Inclusion of the wake-up radio 205 may also reduce latency by allowing for frequent monitoring of WUSs, thereby reducing average latency (e.g., as compared to periodic turning on of a main radio 210 in order to monitor for WUSs). As described herein, in some examples, a UE 115 may be configured to monitor for network information (e.g., SSBs or system information blocks (SIBs)) associated with a network entity 105 via the wake-up radio 205. Similar, the network entity 105 may include a wake-up radio 205 and a main radio 210, and may be configured to monitor for signals (e.g., SRS signals) from the UE 115.

The wake-up radio 205 may be a radio receiver circuit (e.g., non-coherent envelope detector) that is designed to have a low energy consumption. When there is no data to receive, the main radio 210 may be turned off unless there are signals to transmit. The wake-up radio 205 may keep active monitoring through a low power wakeup signal. When there is data to the receiver, the wake-up radio 205 receives on-demand low power WUSs and activates the main radio 210. The data is transmitted and received by the main radio 210. The wake-up radio 205 may not suffer from latency versus efficiency tradeoff since frequent WUS monitoring is enabled to meet latency expectations. The wake-up radio 205 may present lower energy consumption than some of duty-cycling schemes. The wake-up radio 205 may avoid unnecessary main radio 210 wakeup for PDCCH monitoring. In some cases, the network may use different power saving modes, where the modes have no limitation to be off or use a wake-up radio 205.

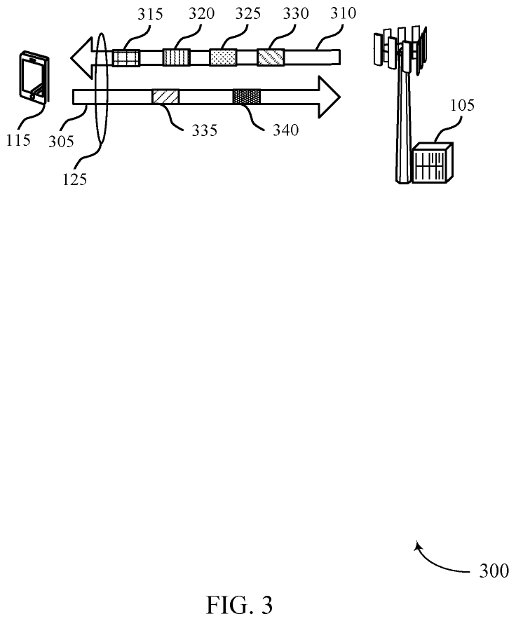

FIG. 3 shows an example of a wireless communications system 300 that supports uplink and downlink measurement management for low power communicating networks and UEs 115 in accordance with various aspects of the present disclosure. In some examples, the wireless communications system 300 may be implemented by or may implement aspects of the wireless communications system 100 and/or the block diagram 200. For example, the wireless communications system 300 includes a UE 115, which may be an example of a UE 115 described with respect to FIG. 1. The wireless communications system 300 also includes a network entity 105, which may be an example of a network entity 105 as described with respect to FIG. 1.

The network entity 105 may communicate with the UE 115 via a communication link 125, which may be an example of an NR or LTE link between the UE 115 and the network entity 105. In some cases, the communication link 125 may include an example of an access link (e.g., Uu link). The communication link 125 may include a bi-directional link that enables both uplink and downlink communication. For example, the UE 115 may transmit uplink signals 305, such as uplink control signals or uplink data signals, to the network entity 105 using the communication link 125, and the network entity 105 may transmit downlink signals 310, such as downlink control signals or downlink data signals, to the UE 115 using the communication link 125.

In some examples, the UE 115 may receive control signaling 315 from the network entity 105 scheduling one or more RRM signals. The RRM signals may be SSBs 330 for downlink RRM or SRSs 335 for uplink RRM.

In some examples, the UE 115 may receive control signals 320 from the network entity 105 indicating a configuration to select a subset of the RRM signals. For example, the configuration may configure the UE 115 to select the subset based on one or more power conditions, such as a first power condition at the UE, a second power condition at the network entity 105, or both. In some examples, the configuration signals may indicate specific power conditions. In some examples, the configuration may indicate how to select the subset of the RRM signals, such as by canceling one or more RRM signals, selecting the subset based on a pattern, based on a priority.

In some examples, the UE 115 may receive a wake-up radio signal 325 from the network entity 105. The WUS may indicate to wake up the main radio of the UE 115. In some examples, the network entity 105 may receive a wake-up radio signal from the UE 115 to wake up the main radio of the network entity 105. The wake-up radio signal 325 may be transmitted from a wake-up radio of the network entity 105 and reception of the wake-up radio signal 325 at the UE 115 may indicate the second power condition at the network entity 105. In some examples, the network entity 105 may receive the subset of RRM signals 340 from the UE 115 indicating the selected subset of RRM signals. The subset of RRM signals may be SRS.

For a UE 115 in an idle or inactive state, the UE 115 may send uplink signals, which may be similar to a MsgA in a 2-step RACH procedure for uplink RRM measurements. For a UE 115 in a connected state with the network entity 105, the UE 115 may send uplink signals, such as SRS, for uplink RRM measurements. The UE 115 may measure SSBs from the network entity 105 and CSI-RS in an idle mode discontinuous reception (I-DRX) configuration, a connected mode discontinuous reception (C-DRX) configuration, or an extended mode discontinuous reception (eDRX) configuration. The UE 115 may apply one or more relaxation methods for RRM measurements based on criteria. For example, in a first relaxation method, measurements with long intervals (e.g., a large scaling factor) may be relaxed and defined. In a second relaxation method, measurements may be stopped for a duration, such as an hour. As discussed herein, uplink and downlink RRM relaxation, cancellation, priority resolving relative to other signals may be used based on communicating device power saving modes and used receivers (e.g., cases where at least one of UE 115 or network entity 105 uses a wake-up radio (e.g., wake-up radio 205 of FIG. 2).

In some examples, the criteria for triggering RRM relaxation may include low mobility and not being at cell edge. A UE 115 may be considered low mobility if (Srxlev_{Ref}−Srxlev)<S_{SearchDeltap} for a period of T_{SearchDeltaP}, where Srxlev_{Ref} refers to a reference cell selection receive level value (in decibels (dB)), Srxlev refers to cell selection receive level value, S_{SearchDeltap} refers to Srxlev delta threshold (in dB) during relaxed monitoring, and T SearchDeltap refers to a time frame for relaxed monitoring.

A UE may be considered not at cell edge when Srxlev>S_{SearchThresholdP}, and Squal>S_{SearchThresholdQ} if S_{SearchThresholdQ} is configured, where Srxlev refers to cell selection RX level value, Squal refers to cell selection quality value, and where S_{SearchThresholdQ} refers to Srxlev threshold during relaxed monitoring.

The network entity 105 may configure the UE 115 to trigger RRM relaxation based on the low mobility condition, the cell edge condition, or both. The UE 115 may apply a specific relaxation method of multiple relaxation methods depending on relaxation criteria met by the UE 115. In the first relaxation method (Method 1), the relaxed measurements may have longer intervals (scaling factor). In the second relaxation method (Method 2), the measurements may be stopped for a specific duration (e.g., 1 hour). Depending on the trigger criteria met by the UE 115, different relaxation methods may be, as summarized in Table 1 below.

TABLE 1

| | | | Both triggering criteria are | |
|---|---|---|---|---|
| | One triggering criteria is | | configured | |
| | configured | | Either one of | |
| | | Not-at-cell- | the criteria is | Both criteria |
| | Low mobility | edge | met | are met |
| Intra-frequency | Method 1 | Method 1 | Method 1 | Method 2 |
| measurements, | | | | |
| inter-frequency of | | | | |
| equal or lower | | | | |
| priority, and inter- | | | | |
| radio access | | | | |
| technology (RAT) | | | | |
| measurements. | | | | |
| High priority inter- | Method 2 if | No relaxation | No relaxation | Method 2 |
| frequency and | Condition 1 is | if condition 1 | if condition 1 | |
| inter-RAT | met. | is met. | is met. | |
| measurements | Otherwise, | Otherwise, | Otherwise, | |
| (condition 1: | method 1 is | Method 1 is | Method 1 is | |
| Srxlev > | applied. | applied. | applied. | |
| SnonIntraSearchP | | | | |
| and Squal > | | | | |
| SnonIntraSearchQ) | | | | |

The present disclosure may facilitate uplink RRM measurements and SRS transmission relaxation or cancellation due to a network power saving state or mode, a UE 115 power saving state or mode, UE 115 energy conditions (e.g., charging rate profile, discharging rate (power consumption) profile, energy level profile), a power control at the UE 115, a UE location, position relative to the network entity 105 (e.g., the gNB), use of the wake-up radio at the UE 115 (may be associated with some power saving mode at UE 115), or use of wake-up radio at the network entity 105 (may be associated with some network solutions). The techniques may include allowing for uplink RRM measurement relaxation and/or cancellation using a layer 1, layer 2, or layer 3 (L1/L2/L3) indication from the network entity 105 or based on priority conflict with other signals/measurements. The techniques may include allowing for uplink RRM measurement cancellation when the network entity 105 is using a wake-up radio (e.g., a UE 115 may be configured to not send uplink RRM measurements at times where the network entity 105 is using the wake-up radio). In some cases, uplink RRM measurements may be canceled if the UE 115 is configured to send wakeup signals (e.g., low power cell wake-up signal (LP-C-WUS)) or lower power signals (low power signals to the network entity 105 (under some network energy services (NES)). For example, the network entity 105 may not measure RRM signals or process RRM signals due to different radio type. The UE 115 may be configured with reference signals and mobility signals that are compatible with the network entity 105 receiver used from one network solutions to the other. The UE 115 may relax or cancel downlink RRM when the network entity 105 is using wake-up radio, since this may indicate that network entity 105 will not send SSBs.

For periodic signals for beam managements or SRS for channel measurement, the resources may be configured with two different configurations, such as one for when the network entity 105 is using a wake-up radio or when the network entity 105 is using a radio without a wake-up radio. The repetition of each measurement signal may be different based on the radio used by the network entity 105, which may be configured per resource or resource set or report configuration.

In some examples, the UE 115 may select an RRM measurement pattern to do K random measurements within M measurement interval, where K and M refer to an integer greater than 0. The UE 115 may generate the pattern initially then apply the pattern to reduce the measurements. The pattern may be a function of channel conditions (e.g., signal to interference and noise ratio (SINR), delay spread, and the like), mobility, cell edge or near edge condition, energy harvesting (EH) conditions at the UE 115 (e.g., EH cycles at UE 115), energy information at the UE 115, network entity power saving and power or energy state, or observed interference.

Parameters K and M nay be L1/L2/L3 configured by the network and may be based on preference from the UE 115, where the UE 115 may send preference in L1/L2/L3 or multiplexed with L1/L2/L3 signaling including user assistance information). In some examples, multiplexing with L1/L2/L3 may include multiplexing with HARQ-ACK, scheduling request (SR), buffer status report (BSR), power headroom report (PHR), CSI, or physical uplink shared channel (PUSCH). In some examples, the UE 115 may indicate an uplink or downlink measurement pattern using the network entity's 105 wake-up radio compatible signals when the network entity 105 is in a mode that uses wake-up radio. In some examples, for a UE 115 using wake-up radio, the uplink or downlink radio resource measurement pattern (e.g., K out of M) may be indicated by the network (e.g., using L1/L2/L3 indications that are compatible with wake-up radio at the UE 115) based on the network's knowledge about channel conditions (e.g., SINR), mobility, cell edge or near edge condition, EH conditions at the UE 115, energy information at the UE 115, network power saving and power or energy state, observed interference, and other predetermined conditions. In some cases, the indication may be received by the main radio using L1/L2/L3 indications.

In some examples, the UE 115 may increase priority of uplink measurements or downlink measurements at a time based on RRM measurement signals being canceled before or not being canceled. The quantity of measurements within the last M measurement occasions may include F(D(I_M), D(I_M−1), D(I_M−2), D(I_M−3), D(I_1), where F is defined function by L1/L2/L3 configuration.

The RRM measurement priority may increase, decrease, or remain the same based on reasons of cancellation. For example, a RRM signal may be canceled because of a higher priority grant or data/request/report transmission or reception that conflicts with the RRM signal, a configured grant or request/report that conflicts with the RRM signal, a dynamic grant or request/report that conflicts with the RRM signal, an EH cycle where the UE 115 cannot receive signals and perform EH in some EH circuit designs (e.g., for time-switch RF EH circuits or architectures), or energy unavailability (no energy at EH devices). In some examples, the cancelation reason may be based on a high mobility of the UE 115 and previous measurement was canceled due to more important grant or request or CSI-RS or report or SRS (in case of uplink measurements), then the priority may increase for the RRM measurement. The amount of increase in priority may be based on the reason of cancellation, mobility, proximity from cell (e.g., near or far cell), channel conditions, and so forth. In some examples, the conditions and amount of increase or enabling these features may depend on an RRC state. In some examples, a RRM measurement may be canceled or there may be a priority-based selection between a RRM measurement versus other signals when the RRM measurement relaxation occurs (either with the previous two conditions for RRM measurement relaxation in downlink or as in redcap based on network configuration for power saving). The UE 115 and network may be aware of the downlink and uplink relaxation intervals and times (this can be using L1/L2/L3 signals from the UE 115 to the network entity 105, from the network entity 105 to the UE 115, or both, or broadcast signaling for the network entity 105 where it can send the information in a master information block (MIB), a system information block (SIB1), or a on request system information block (OSIB)).

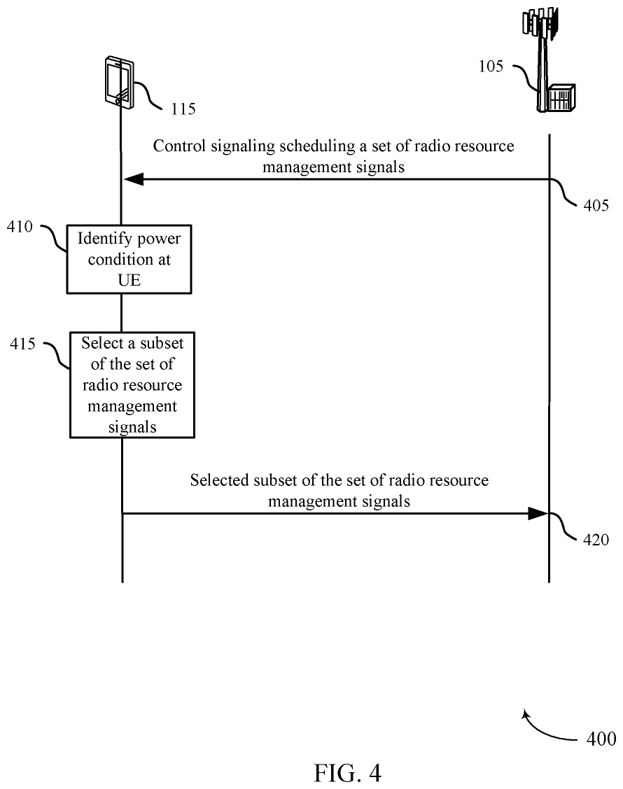

FIG. 4 shows an example of a process flow 400 that supports uplink and downlink measurement management for low power communicating networks and UEs 115 in accordance with various aspects of the present disclosure. The process flow 400 may include a UE 115, which may be an example of UE 115, as described herein. The process flow 400 may also include a network entity 105, which may be an example of network entity 105, as described herein.

In the following description of the process flow 400, the operations between the network entity 105 and the UE 115 may be transmitted in a different order than the example order shown, or the operations performed by the network entity 105 and the UE 115 may be performed in different orders or at different times. Some operations may also be omitted from the process flow 400, and other operations may be added to the process flow 400.

At 405, the network entity 105 may transmit control signaling that schedules a set of RRM signals. In some examples, the set of RRM signals may be a set of SSBs. In some examples, the UE 115 may receive control signaling indicating a configuration for selecting a subset of the set of RRM signals when a first power condition at the UE 115 or a second power condition at the network entity 105 occur.

At 410, the UE 115 may identify the power condition at the UE 115. The power condition may be based on using a WUR at the UE 115. In some examples, the first power condition includes the UE 115 being at a cell edge. In some examples, the UE may receive an indication of a low power state or the second power condition at the network entity 105. In some examples, the UE 115 may receive a signal transmitted via a wake-up radio of the network entity 105, where reception of the signal indicates the second power condition at the network entity 105.

At 415, the UE 115 may select a subset of the set of RRM signals. In some examples, selecting the subset of the set of RRM signals includes canceling at least one of the set of RRM signals in accordance with a pattern, based on a first priority of the RRM signal being less than a second priority of a signal that overlaps with the RRM signal, or based on the increased priority of the RRM signal. In some examples, selecting the subset of includes increasing a priority of a RRM signal of the set of RRM signals based on canceling a prior RRM signal of the set of RRM signals, as well as canceling a signal that overlaps with the RRM signal based on the increased priority of the RRM signal.

At 420, the network entity 105 receives a selected subset of the set of RRM signals from the UE 115. In some examples, the set of RRM signals include sounding reference signals. Communicating the subset of the set of RRM signals includes transmitting a subset of the set of sounding reference signals.

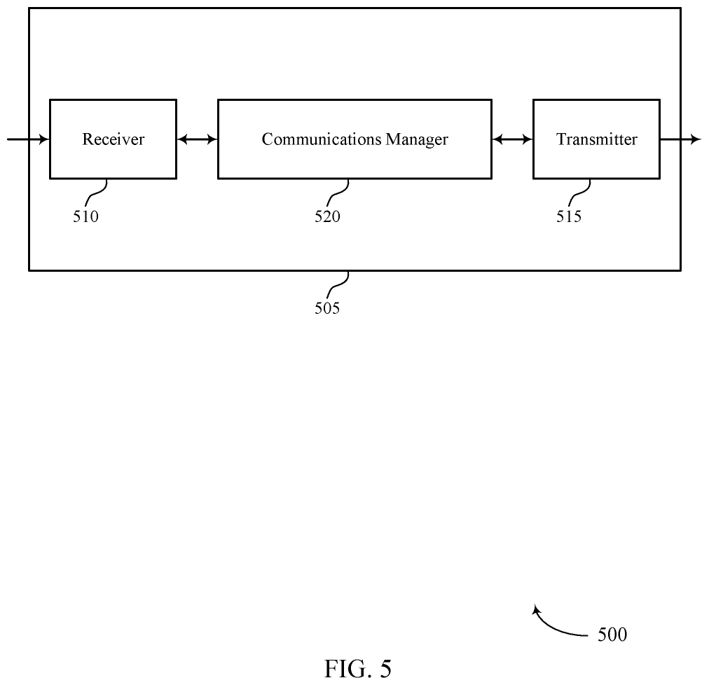

FIG. 5 shows a block diagram 500 of a device 505 that supports uplink and downlink measurement management for low power communicating networks and UEs in accordance with various aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to uplink and downlink measurement management for low power communicating networks and UEs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to uplink and downlink measurement management for low power communicating networks and UEs). In some examples, the transmitter 515 may be co-located with a receiver 510 in a transceiver component. The transmitter 515 may utilize a single antenna or a set of multiple antennas.

The communications manager 520, the receiver 510, the transmitter 515, or various combinations thereof or various components thereof may be examples of means for performing various aspects of uplink and downlink measurement management for low power communicating networks and UEs as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 is capable of, configured to, or operable to support a means for receiving, from a network entity, control signaling scheduling a set of RRM signals. The communications manager 520 is capable of, configured to, or operable to support a means for identifying a first power condition at the UE. The communications manager 520 is capable of, configured to, or operable to support a means for selecting a subset of the set of RRM signals based on the identified first power condition at the UE, a second power condition at the network entity, or a combination thereof. The communications manager 520 is capable of, configured to, or operable to support a means for communicating, with the network entity, the subset of the set of RRM signals.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for RRM measurements accommodating power conditions or a low power mode at the UE 115 or network entity 105.

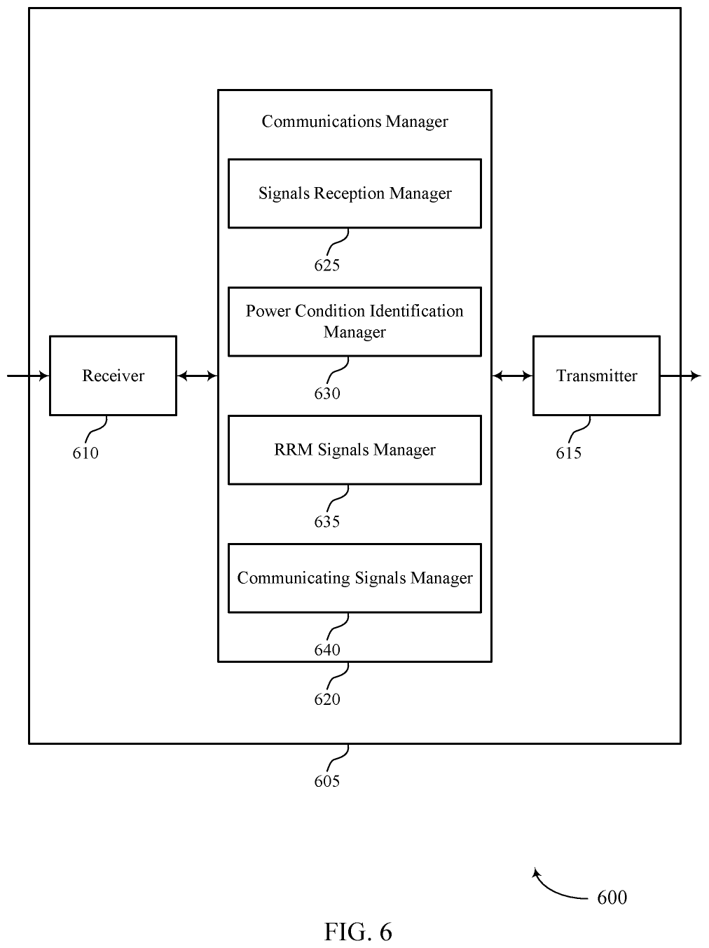

FIG. 6 shows a block diagram 600 of a device 605 that supports uplink and downlink measurement management for low power communicating networks and UEs in accordance with various aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink and downlink measurement management for low power communicating networks and UEs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink and downlink measurement management for low power communicating networks and UEs). In some examples, the transmitter 615 may be co-located with a receiver 610 in a transceiver component. The transmitter 615 may utilize a single antenna or a set of multiple antennas.

The device 605, or various components thereof, may be an example of means for performing various aspects of uplink and downlink measurement management for low power communicating networks and UEs as described herein. For example, the communications manager 620 may include a signals reception manager 625, a power condition identification manager 630, a RRM signals manager 635, a communicating signals manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The signals reception manager 625 is capable of, configured to, or operable to support a means for receiving, from a network entity, control signaling scheduling a set of RRM signals. The power condition identification manager 630 is capable of, configured to, or operable to support a means for identifying a first power condition at the UE. The RRM signals manager 635 is capable of, configured to, or operable to support a means for selecting a subset of the set of RRM signals based on the identified first power condition at the UE, a second power condition at the network entity, or a combination thereof. The communicating signals manager 640 is capable of, configured to, or operable to support a means for communicating, with the network entity, the subset of the set of RRM signals.

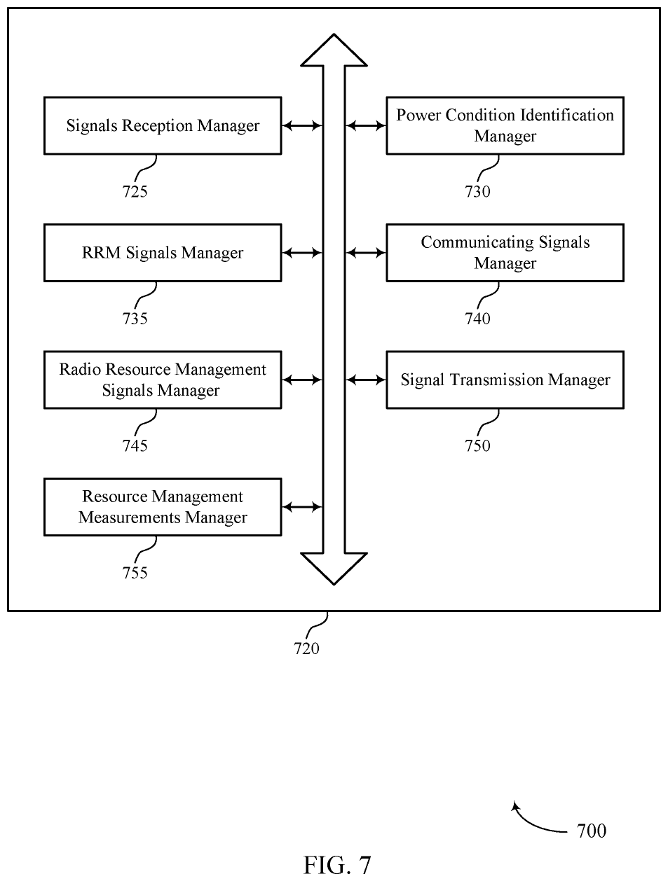

FIG. 7 shows a block diagram 700 of a communications manager 720 that supports uplink and downlink measurement management for low power communicating networks and UEs in accordance with various aspects of the present disclosure. The communications manager 720 may be an example of aspects of a communications manager 520, a communications manager 620, or both, as described herein. The communications manager 720, or various components thereof, may be an example of means for performing various aspects of uplink and downlink measurement management for low power communicating networks and UEs as described herein. For example, the communications manager 720 may include a signals reception manager 725, a power condition identification manager 730, a RRM signals manager 735, a communicating signals manager 740, a RRM signals manager 745, a signal transmission manager 750, a resource management measurements manager 755, or any combination thereof. Each of these components may communicate, directly or indirectly, with one another (e.g., via one or more buses).

The communications manager 720 may support wireless communications at a UE in accordance with examples as disclosed herein. The signals reception manager 725 is capable of, configured to, or operable to support a means for receiving, from a network entity, control signaling scheduling a set of RRM signals. The power condition identification manager 730 is capable of, configured to, or operable to support a means for identifying a first power condition at the UE. The RRM signals manager 735 is capable of, configured to, or operable to support a means for selecting a subset of the set of RRM signals based on the identified first power condition at the UE, a second power condition at the network entity, or a combination thereof. The communicating signals manager 740 is capable of, configured to, or operable to support a means for communicating, with the network entity, the subset of the set of RRM signals.

In some examples, to support selecting the subset of the set of RRM signals, the RRM signals manager 735 is capable of, configured to, or operable to support a means for canceling at least one of the set of RRM signals.

In some examples, to support selecting the subset of the set of RRM signals, the RRM signals manager 745 is capable of, configured to, or operable to support a means for selecting the subset of the set of RRM signals in accordance with a pattern.

In some examples, the signals reception manager 725 is capable of, configured to, or operable to support a means for receiving control signaling indicating a configuration for selecting the subset of the set of RRM signals when the first power condition or the second power condition occurs.

In some examples, to support selecting the subset of the set of RRM signals, the RRM signals manager 735 is capable of, configured to, or operable to support a means for canceling a RRM signal of the set of RRM signals based on a first priority of the RRM signal being less than a second priority of a signal that overlaps with the RRM signal.

In some examples, to support selecting the subset of, the RRM signals manager 735 is capable of, configured to, or operable to support a means for increasing a priority of a RRM signal of the set of RRM signals based on canceling a prior RRM signal of the set of RRM signals.

In some examples, the RRM signals manager 735 is capable of, configured to, or operable to support a means for canceling a signal that overlaps with the RRM signal based on the increased priority of the RRM signal.

In some examples, to support communicating the subset of the set of RRM signals, the signal transmission manager 750 is capable of, configured to, or operable to support a means for transmitting a subset of the set of sounding reference signals.

In some examples, to support communicating the subset of the set of RRM signals, the signals reception manager 725 is capable of, configured to, or operable to support a means for receiving a subset of the set of synchronization signal blocks.

In some examples, the resource management measurements manager 755 is capable of, configured to, or operable to support a means for performing RRM measurements on the subset of the set of synchronization signal blocks.

In some examples, the signals reception manager 725 is capable of, configured to, or operable to support a means for receiving a signal transmitted via a wake-up radio of the network entity, where reception of the signal indicates the second power condition.

In some examples, identifying the first power condition is based on use of a wake-up radio at the UE.

In some examples, the power condition identification manager 730 is capable of, configured to, or operable to support a means for receiving an indication of a low power state or the second power condition at the network entity.

In some examples, the identified first power condition includes the UE being at a cell edge.

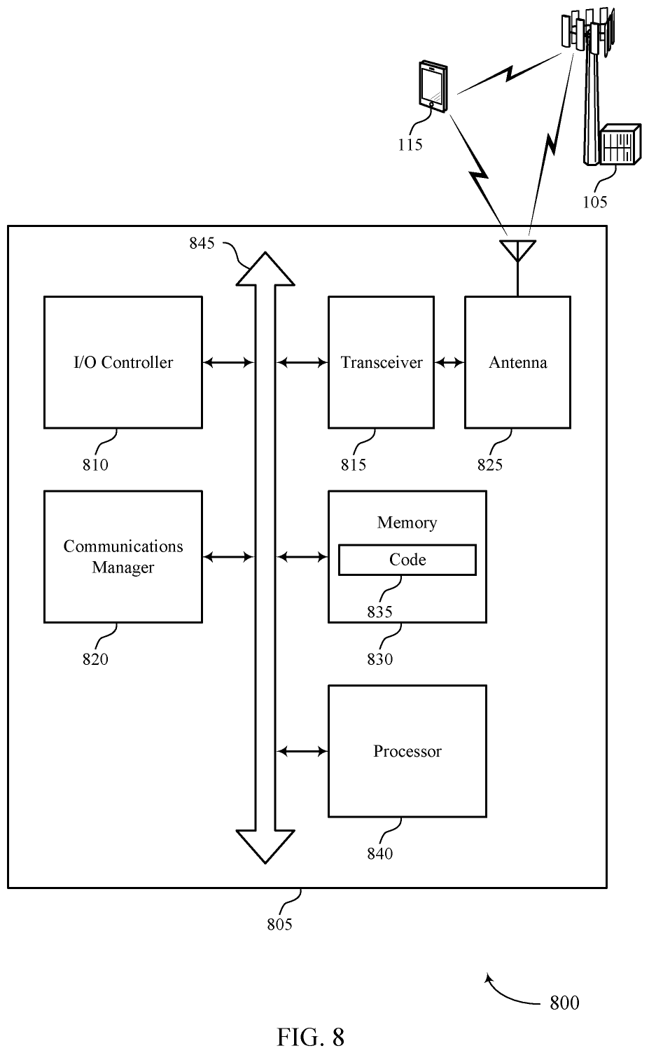

FIG. 8 shows a diagram of a system 800 including a device 805 that supports uplink and downlink measurement management for low power communicating networks and UEs in accordance with various aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting uplink and downlink measurement management for low power communicating networks and UEs). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 is capable of, configured to, or operable to support a means for receiving, from a network entity, control signaling scheduling a set of RRM signals. The communications manager 820 is capable of, configured to, or operable to support a means for identifying a first power condition at the UE. The communications manager 820 is capable of, configured to, or operable to support a means for selecting a subset of the set of RRM signals based on the identified first power condition at the UE, a second power condition at the network entity, or a combination thereof. The communications manager 820 is capable of, configured to, or operable to support a means for communicating, with the network entity, the subset of the set of RRM signals.

By including or configuring the communications manager 820 in accordance with examples as described herein, the device 805 may support techniques for RRM measurements accommodating power conditions or a low power mode at the UE 115 or network entity 105.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of uplink and downlink measurement management for low power communicating networks and UEs as described herein, or the processor 840 and the memory 830 may be otherwise configured to perform or support such operations.

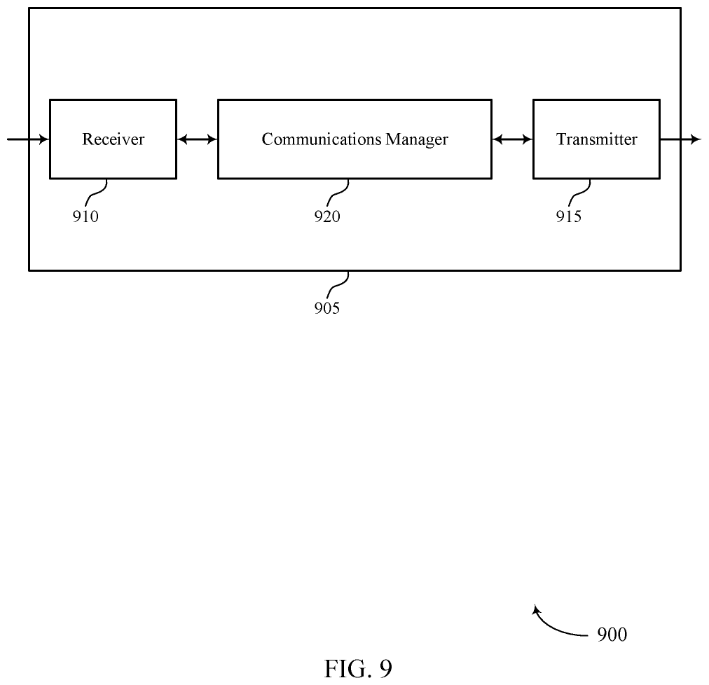

FIG. 9 shows a block diagram 900 of a device 905 that supports uplink and downlink measurement management for low power communicating networks and UEs in accordance with various aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of uplink and downlink measurement management for low power communicating networks and UEs as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 is capable of, configured to, or operable to support a means for transmitting, to a UE, control signaling scheduling a set of RRM signals. The communications manager 920 is capable of, configured to, or operable to support a means for identifying a second power condition at the network entity. The communications manager 920 is capable of, configured to, or operable to support a means for selecting a subset of the set of RRM signals based on a first power condition at the UE, the identified second power condition at the network entity, or a combination thereof. The communications manager 920 is capable of, configured to, or operable to support a means for communicating, with the UE, the subset of the set of RRM signals.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for RRM measurements accommodating power conditions or a low power mode at the UE 115 or network entity 105.

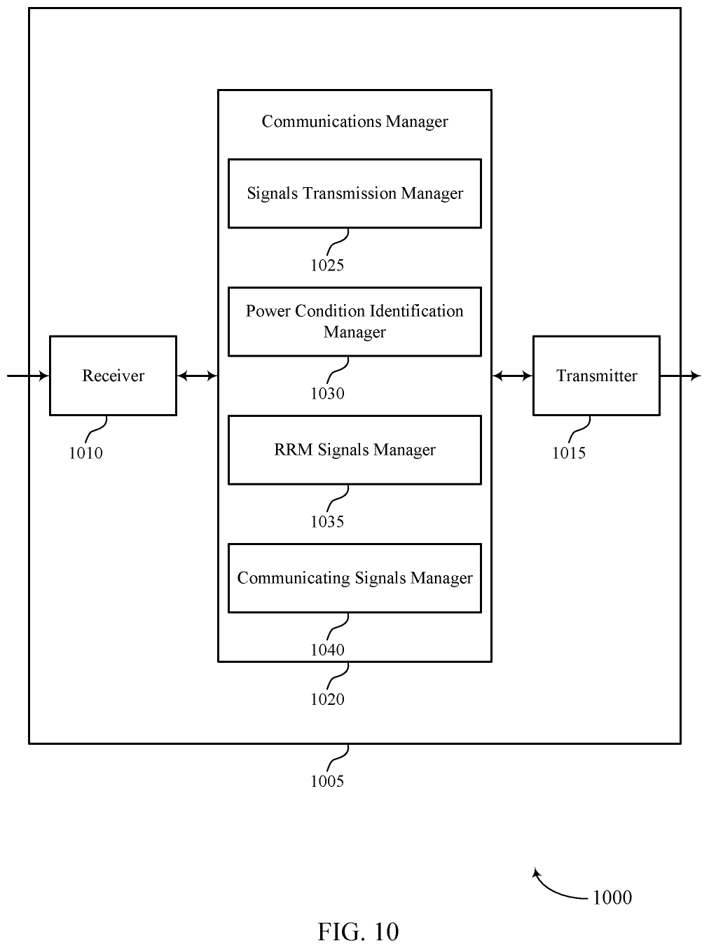

FIG. 10 shows a block diagram 1000 of a device 1005 that supports uplink and downlink measurement management for low power communicating networks and UEs in accordance with various aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of uplink and downlink measurement management for low power communicating networks and UEs as described herein. For example, the communications manager 1020 may include a signals transmission manager 1025, a power condition identification manager 1030, a RRM signals manager 1035, a communicating signals manager 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The signals transmission manager 1025 is capable of, configured to, or operable to support a means for transmitting, to a UE, control signaling scheduling a set of RRM signals. The power condition identification manager 1030 is capable of, configured to, or operable to support a means for identifying a second power condition at the network entity. The RRM signals manager 1035 is capable of, configured to, or operable to support a means for selecting a subset of the set of RRM signals based on a first power condition at the UE, the identified second power condition at the network entity, or a combination thereof. The communicating signals manager 1040 is capable of, configured to, or operable to support a means for communicating, with the UE, the subset of the set of RRM signals.

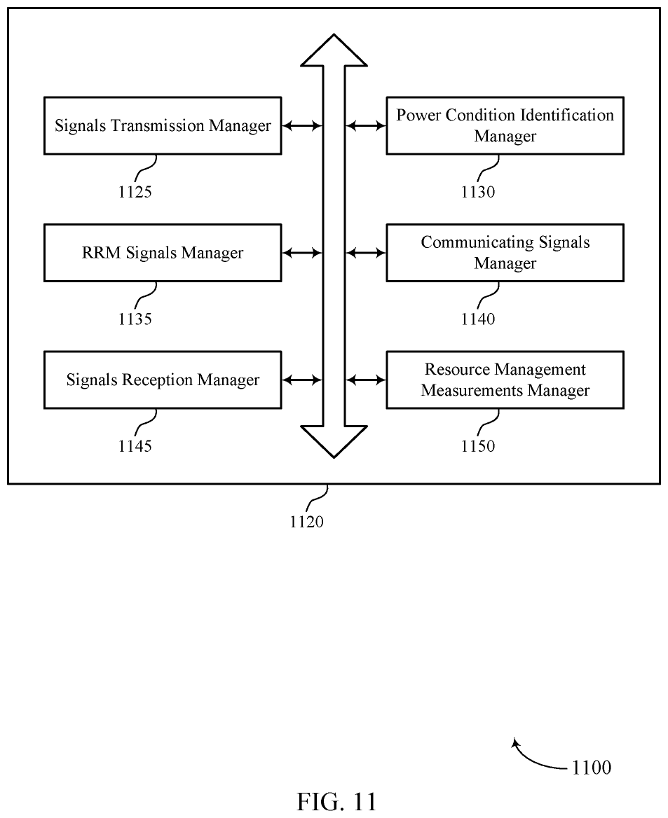

FIG. 11 shows a block diagram 1100 of a communications manager 1120 that supports uplink and downlink measurement management for low power communicating networks and UEs in accordance with various aspects of the present disclosure. The communications manager 1120 may be an example of aspects of a communications manager 920, a communications manager 1020, or both, as described herein. The communications manager 1120, or various components thereof, may be an example of means for performing various aspects of uplink and downlink measurement management for low power communicating networks and UEs as described herein. For example, the communications manager 1120 may include a signals transmission manager 1125, a power condition identification manager 1130, a RRM signals manager 1135, a communicating signals manager 1140, a signals reception manager 1145, a resource management measurements manager 1150, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The signals transmission manager 1125 is capable of, configured to, or operable to support a means for transmitting, to a UE, control signaling scheduling a set of RRM signals. The power condition identification manager 1130 is capable of, configured to, or operable to support a means for identifying a second power condition at the network entity. The RRM signals manager 1135 is capable of, configured to, or operable to support a means for selecting a subset of the set of RRM signals based on a first power condition at the UE, the identified second power condition at the network entity, or a combination thereof. The communicating signals manager 1140 is capable of, configured to, or operable to support a means for communicating, with the UE, the subset of the set of RRM signals.

In some examples, to support selecting the subset of the set of RRM signals, the RRM signals manager 1135 is capable of, configured to, or operable to support a means for canceling at least one of the set of RRM signals.

In some examples, the resource management measurements manager 1150 is capable of, configured to, or operable to support a means for performing RRM measurements on the subset of the set of sounding reference signals.

In some examples, to support selecting the subset of the set of RRM signals, the RRM signals manager 1135 is capable of, configured to, or operable to support a means for selecting the subset of the set of RRM signals in accordance with a pattern.

In some examples, the signals transmission manager 1125 is capable of, configured to, or operable to support a means for transmitting, to the UE, control signaling indicating a configuration for selecting the subset of the set of RRM signals when the first power condition or the second power condition occurs.

In some examples, to support selecting the subset of the set of RRM signals, the RRM signals manager 1135 is capable of, configured to, or operable to support a means for canceling a RRM signal of the set of RRM signals based on a first priority of the set of RRM signals being less than a second priority of a signal that overlaps with the set of RRM signals.

In some examples, to support selecting the subset of the set of RRM signals, the RRM signals manager 1135 is capable of, configured to, or operable to support a means for increasing a priority of a RRM signal of the set of RRM signals based on canceling a prior RRM signal of the set of RRM signals.

In some examples, the RRM signals manager 1135 is capable of, configured to, or operable to support a means for canceling a signal that overlaps with the RRM signal based on the increased priority of the RRM signal.

In some examples, to support communicating the subset of the set of RRM signals, the signals reception manager 1145 is capable of, configured to, or operable to support a means for receiving a subset of the set of sounding reference signals.

In some examples, to support communicating the subset of the set of RRM signals, the signals transmission manager 1125 is capable of, configured to, or operable to support a means for transmitting the subset of the set of synchronization signal blocks.

In some examples, the signals transmission manager 1125 is capable of, configured to, or operable to support a means for transmitting a signal via a wake-up radio of the network entity, where identifying the second power condition is based on transmission of the signal.

In some examples, the first power condition includes use of a wake-up radio at the UE.

In some examples, the power condition identification manager 1130 is capable of, configured to, or operable to support a means for transmitting, to the UE, an indication of a low power state or the second power condition at the network entity.

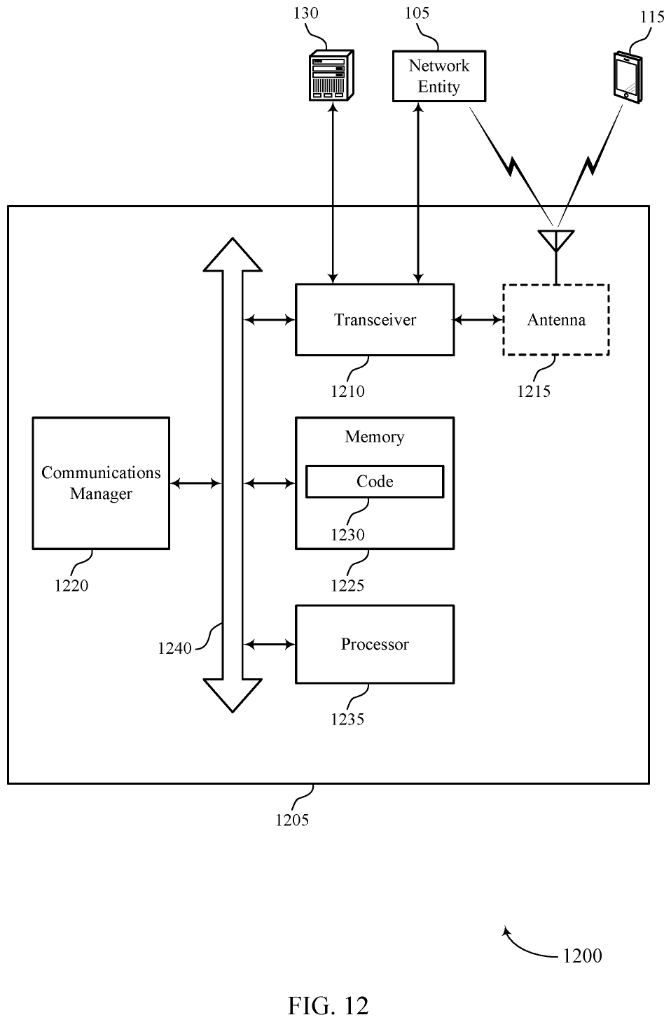

FIG. 12 shows a diagram of a system 1200 including a device 1205 that supports uplink and downlink measurement management for low power communicating networks and UEs in accordance with various aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting uplink and downlink measurement management for low power communicating networks and UEs). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may, for example, refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 is capable of, configured to, or operable to support a means for transmitting, to a UE, control signaling scheduling a set of RRM signals. The communications manager 1220 is capable of, configured to, or operable to support a means for identifying a second power condition at the network entity. The communications manager 1220 is capable of, configured to, or operable to support a means for selecting a subset of the set of RRM signals based on a first power condition at the UE, the identified second power condition at the network entity, or a combination thereof. The communications manager 1220 is capable of, configured to, or operable to support a means for communicating, with the UE, the subset of the set of RRM signals.

By including or configuring the communications manager 1220 in accordance with examples as described herein, the device 1205 may support techniques for RRM measurements accommodating power conditions or a low power mode at the UE 115 or network entity 105.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of uplink and downlink measurement management for low power communicating networks and UEs as described herein, or the processor 1235 and the memory 1225 may be otherwise configured to perform or support such operations.

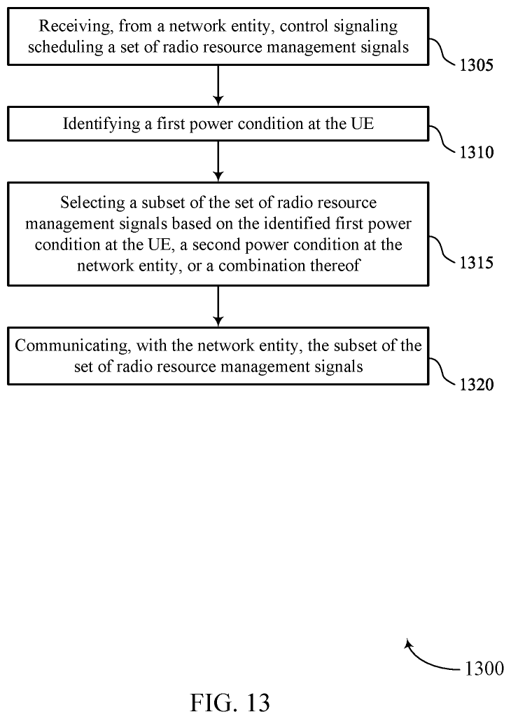

FIG. 13 shows a flowchart illustrating a method 1300 that supports uplink and downlink measurement management for low power communicating networks and UEs in accordance with various aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the wireless UE to perform the described functions. Additionally, or alternatively, the wireless UE may perform aspects of the described functions using special-purpose hardware.

At 1305, the method may include receiving, from a network entity, control signaling scheduling a set of RRM signals. The operations of 1305 may be performed in accordance with examples as disclosed herein. In some examples, aspects of the operations of 1305 may be performed by a signals reception manager 725 as described with reference to FIG. 7.

At 1310, the method may include identifying a first power condition at the UE. The operations of 1310 may be performed in accordance with examples as disclosed herein. In some examples, aspects of the operations of 1310 may be performed by a power condition identification manager 730 as described with reference to FIG. 7.

At 1315, the method may include selecting a subset of the set of RRM signals based on the identified first power condition at the UE, a second power condition at the network entity, or a combination thereof. The operations of 1315 may be performed in accordance with examples as disclosed herein. In some examples, aspects of the operations of 1315 may be performed by a RRM signals manager 735 as described with reference to FIG. 7.

At 1320, the method may include communicating, with the network entity, the subset of the set of RRM signals. The operations of 1320 may be performed in accordance with examples as disclosed herein. In some examples, aspects of the operations of 1320 may be performed by a communicating signals manager 740 as described with reference to FIG. 7.

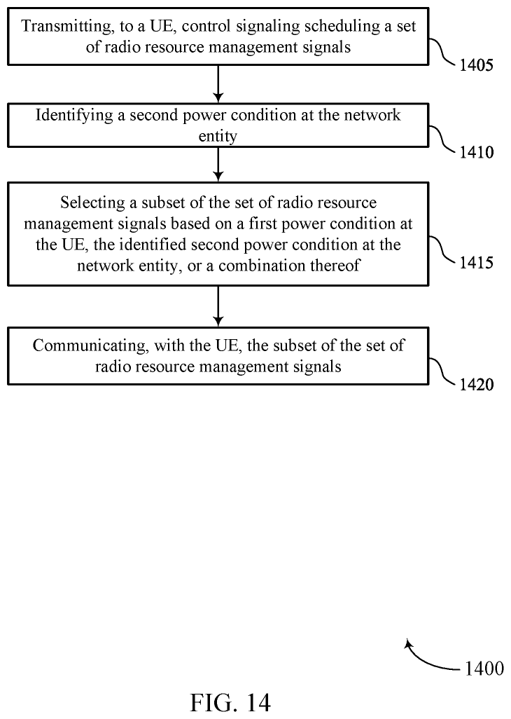

FIG. 14 shows a flowchart illustrating a method 1400 that supports uplink and downlink measurement management for low power communicating networks and UEs in accordance with various aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the wireless network entity to perform the described functions. Additionally, or alternatively, the wireless network entity may perform aspects of the described functions using special-purpose hardware.

At 1405, the method may include transmitting, to a UE, control signaling scheduling a set of RRM signals. The operations of 1405 may be performed in accordance with examples as disclosed herein. In some examples, aspects of the operations of 1405 may be performed by a signals transmission manager 1125 as described with reference to FIG. 11.

At 1410, the method may include identifying a second power condition at the network entity. The operations of 1410 may be performed in accordance with examples as disclosed herein. In some examples, aspects of the operations of 1410 may be performed by a power condition identification manager 1130 as described with reference to FIG. 11.

At 1415, the method may include selecting a subset of the set of RRM signals based on a first power condition at the UE, the identified second power condition at the network entity, or a combination thereof. The operations of 1415 may be performed in accordance with examples as disclosed herein. In some examples, aspects of the operations of 1415 may be performed by a RRM signals manager 1135 as described with reference to FIG. 11.

At 1420, the method may include communicating, with the UE, the subset of the set of RRM signals. The operations of 1420 may be performed in accordance with examples as disclosed herein. In some examples, aspects of the operations of 1420 may be performed by a communicating signals manager 1140 as described with reference to FIG. 11.

The following provides an overview of aspects of the present disclosure:

Aspect 1: A method for wireless communications at a UE, comprising: receiving, from a network entity, control signaling scheduling a set of radio resource management signals; identifying a first power condition at the UE; selecting a subset of the set of radio resource management signals based at least in part on the identified first power condition at the UE, a second power condition at the network entity, or a combination thereof; and communicating, with the network entity, the subset of the set of radio resource management signals.

Aspect 2: The method of aspect 1, wherein selecting the subset of the set of radio resource management signals comprises: canceling at least one of the set of radio resource management signals.

Aspect 3: The method of any of aspects 1 through 2, wherein selecting the subset of the set of radio resource management signals comprises: selecting the subset of the set of radio resource management signals in accordance with a pattern.

Aspect 4: The method of any of aspects 1 through 3, further comprising: receiving control signaling indicating a configuration for selecting the subset of the set of radio resource management signals when the first power condition or the second power condition occurs.

Aspect 5: The method of any of aspects 1 through 4, wherein selecting the subset of the set of radio resource management signals comprises: canceling a radio resource management signal of the set of radio resource management signals based at least in part on a first priority of the radio resource management signal being less than a second priority of a signal that overlaps with the radio resource management signal.

Aspect 6: The method of any of aspects 1 through 5, wherein selecting the subset of comprises: increasing a priority of a radio resource management signal of the set of radio resource management signals based on canceling a prior radio resource management signal of the set of radio resource management signals.

Aspect 7: The method of aspect 6, further comprising: canceling a signal that overlaps with the radio resource management signal based on the increased priority of the radio resource management signal.

Aspect 8: The method of any of aspects 1 through 7, wherein the set of radio resource management signals are a set of sounding reference signals, and wherein communicating the subset of the set of radio resource management signals comprises:

transmitting a subset of the set of sounding reference signals.

Aspect 9: The method of any of aspects 1 through 8, wherein the set of radio resource management signals are a set of synchronization signal blocks, and wherein communicating the subset of the set of radio resource management signals comprises: receiving a subset of the set of synchronization signal blocks.

Aspect 10: The method of aspect 9, further comprising: performing radio resource management measurements on the subset of the set of synchronization signal blocks.

Aspect 11: The method of any of aspects 1 through 10, further comprising: receiving a signal transmitted via a wake-up radio of the network entity, wherein reception of the signal indicates the second power condition.

Aspect 12: The method of any of aspects 1 through 11, wherein identifying the first power condition is based at least in part on use of a wake-up radio at the UE.

Aspect 13: The method of any of aspects 1 through 12, further comprising: receiving an indication of a low power state or the second power condition at the network entity.

Aspect 14: The method of any of aspects 1 through 13, wherein the identified first power condition comprises the UE being at a cell edge.

Aspect 15: A method for wireless communications at a network entity, comprising: transmitting, to a UE, control signaling scheduling a set of radio resource management signals; identifying a second power condition at the network entity selecting a subset of the set of radio resource management signals based at least in part on a first power condition at the UE, the identified second power condition at the network entity, or a combination thereof; and communicating, with the UE, the subset of the set of radio resource management signals.

Aspect 16: The method of aspect 15, wherein selecting the subset of the set of radio resource management signals comprises: canceling at least one of the set of radio resource management signals.

Aspect 17: The method of aspect 16, further comprising: performing radio resource management measurements on the subset of the set of sounding reference signals.

Aspect 18: The method of any of aspects 15 through 17, wherein selecting the subset of the set of radio resource management signals comprises: selecting the subset of the set of radio resource management signals in accordance with a pattern.

Aspect 19: The method of any of aspects 15 through 18, further comprising: transmitting, to the UE, control signaling indicating a configuration for selecting the subset of the set of radio resource management signals when the first power condition or the second power condition occurs.

Aspect 20: The method of any of aspects 15 through 19, wherein selecting the subset of the set of radio resource management signals comprises: canceling a radio resource management signal of the set of radio resource management signals based at least in part on a first priority of the set of radio resource management signals being less than a second priority of a signal that overlaps with the set of radio resource management signals.

Aspect 21: The method of any of aspects 15 through 20, wherein selecting the subset of the set of radio resource management signals comprises: increasing a priority of a radio resource management signal of the set of radio resource management signals based on canceling a prior radio resource management signal of the set of radio resource management signals.

Aspect 22: The method of aspect 21, further comprising: canceling a signal that overlaps with the radio resource management signal based on the increased priority of the radio resource management signal.

Aspect 23: The method of any of aspects 15 through 22, wherein the set of radio resource management signals are a set of sounding reference signals, and wherein communicating the subset of the set of radio resource management signals comprises: receiving a subset of the set of sounding reference signals.

Aspect 24: The method of any of aspects 15 through 23, wherein the set of radio resource management signals are a set of synchronization signal blocks, and wherein communicating the subset of the set of radio resource management signals comprises: transmitting the subset of the set of synchronization signal blocks.

Aspect 25: The method of any of aspects 15 through 24, further comprising: transmitting a signal via a wake-up radio of the network entity, wherein identifying the second power condition is based at least in part on transmission of the signal.

Aspect 26: The method of any of aspects 15 through 25, wherein the first power condition comprises use of a wake-up radio at the UE.

Aspect 27: The method of any of aspects 15 through 26, further comprising: transmitting, to the UE, an indication of a low power state or the second power condition at the network entity.

Aspect 28: An apparatus for wireless communications at a UE, comprising a processor; memory coupled with the processor; and instructions stored in the memory and executable by the processor to cause the apparatus to perform a method of any of aspects 1 through 14.

Aspect 29: An apparatus for wireless communications at a UE, comprising at least one means for performing a method of any of aspects 1 through 14.

Aspect 30: A non-transitory computer-readable medium storing code for wireless communications at a UE, the code comprising instructions executable by a processor to perform a method of any of aspects 1 through 14.

Aspect 31: An apparatus for wireless communications at a network entity, comprising a processor; memory coupled with the processor; and instructions stored in the memory and executable by the processor to cause the apparatus to perform a method of any of aspects 15 through 27.

Aspect 32: An apparatus for wireless communications at a network entity, comprising at least one means for performing a method of any of aspects 15 through 27.

Aspect 33: A non-transitory computer-readable medium storing code for wireless communications at a network entity, the code comprising instructions executable by a processor to perform a method of any of aspects 15 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a network entity, control signaling scheduling a set of radio resource management signals;
identifying a first power condition at the UE;
selecting a subset of the set of radio resource management signals based at least in part on the identified first power condition at the UE, a second power condition at the network entity, or a combination thereof; and
communicating, with the network entity, the subset of the set of radio resource management signals.

2. The method of claim 1, wherein selecting the subset of the set of radio resource management signals comprises:
canceling at least one of the set of radio resource management signals.

3. The method of claim 1, wherein selecting the subset of the set of radio resource management signals comprises:
selecting the subset of the set of radio resource management signals in accordance with a pattern.

4. The method of claim 1, further comprising:
receiving control signaling indicating a configuration for selecting the subset of the set of radio resource management signals when the first power condition or the second power condition occurs.

5. The method of claim 1, wherein selecting the subset of the set of radio resource management signals comprises:
canceling a radio resource management signal of the set of radio resource management signals based at least in part on a first priority of the radio resource management signal being less than a second priority of a signal that overlaps with the radio resource management signal.

6. The method of claim 1, wherein selecting the subset of comprises:
increasing a priority of a radio resource management signal of the set of radio resource management signals based on canceling a prior radio resource management signal of the set of radio resource management signals.

7. The method of claim 6, further comprising:
canceling a signal that overlaps with the radio resource management signal based on the increased priority of the radio resource management signal.

8. The method of claim 1, wherein the set of radio resource management signals are a set of sounding reference signals, and wherein communicating the subset of the set of radio resource management signals comprises:
transmitting a subset of the set of sounding reference signals.

9. The method of claim 1, wherein the set of radio resource management signals are a set of synchronization signal blocks, and wherein communicating the subset of the set of radio resource management signals comprises:
receiving a subset of the set of synchronization signal blocks.

10. The method of claim 9, further comprising:
performing radio resource management measurements on the subset of the set of synchronization signal blocks.

11. The method of claim 1, further comprising:
receiving a signal transmitted via a wake-up radio of the network entity, wherein reception of the signal indicates the second power condition.

12. The method of claim 1, wherein identifying the first power condition is based at least in part on use of a wake-up radio at the UE.

13. The method of claim 1, further comprising:
receiving an indication of a low power state or the second power condition at the network entity.

14. The method of claim 1, wherein the identified first power condition comprises the UE being at a cell edge.

15. A method for wireless communications at a network entity, comprising:
transmitting, to a user equipment (UE), control signaling scheduling a set of radio resource management signals;
identifying a second power condition at the network entity;
selecting a subset of the set of radio resource management signals based at least in part on a first power condition at the UE, the identified second power condition at the network entity, or a combination thereof; and
communicating, with the UE, the subset of the set of radio resource management signals.

16. The method of claim 15, wherein selecting the subset of the set of radio resource management signals comprises:
canceling at least one of the set of radio resource management signals.

17. The method of claim 16, further comprising:
performing radio resource management measurements on the subset of the set of radio resource management signals.

18. The method of claim 15, wherein selecting the subset of the set of radio resource management signals comprises:
selecting the subset of the set of radio resource management signals in accordance with a pattern.

19. The method of claim 15, further comprising:
transmitting, to the UE, control signaling indicating a configuration for selecting the subset of the set of radio resource management signals when the first power condition or the second power condition occurs.

20. The method of claim 15, wherein selecting the subset of the set of radio resource management signals comprises:
canceling a radio resource management signal of the set of radio resource management signals based at least in part on a first priority of the set of radio resource management signals being less than a second priority of a signal that overlaps with the set of radio resource management signals.

21. The method of claim 15, wherein selecting the subset of the set of radio resource management signals comprises:
increasing a priority of a radio resource management signal of the set of radio resource management signals based on canceling a prior radio resource management signal of the set of radio resource management signals.

22. The method of claim 21, further comprising:
canceling a signal that overlaps with the radio resource management signal based on the increased priority of the radio resource management signal.

23. The method of claim 15, wherein the set of radio resource management signals are a set of sounding reference signals, and wherein communicating the subset of the set of radio resource management signals comprises:
receiving a subset of the set of sounding reference signals.

24. The method of claim 15, wherein the set of radio resource management signals are a set of synchronization signal blocks, and wherein communicating the subset of the set of radio resource management signals comprises:
transmitting the subset of the set of synchronization signal blocks.

25. The method of claim 15, further comprising:
transmitting a signal via a wake-up radio of the network entity, wherein identifying the second power condition is based at least in part on transmission of the signal.

26. The method of claim 15, wherein the first power condition comprises use of a wake-up radio at the UE.

27. The method of claim 15, further comprising:
transmitting, to the UE, an indication of a low power state or the second power condition at the network entity.

28. An apparatus for wireless communications at a user equipment (UE), comprising:
a processor;
memory coupled with the processor; and
instructions stored in the memory and executable by the processor to cause the apparatus to:
receive, from a network entity, control signaling scheduling a set of radio resource management signals;
identify a first power condition at the UE;
select a subset of the set of radio resource management signals based at least in part on the identified first power condition at the UE, a second power condition at the network entity, or a combination thereof; and
communicating, with the network entity, the subset of the set of radio resource management signals.

29. The apparatus of claim 28, wherein the instructions to select the subset of the set of radio resource management signals are executable by the processor to cause the apparatus to:
cancel at least one of the set of radio resource management signals.

30. An apparatus for wireless communications at a network entity, comprising:
a processor;
memory coupled with the processor; and
instructions stored in the memory and executable by the processor to cause the apparatus to:
transmit, to a user equipment (UE), control signaling scheduling a set of radio resource management signals;
identify a second power condition at the network entity;
select a subset of the set of radio resource management signals based at least in part on a first power condition at the UE, the identified second power condition at the network entity, or a combination thereof; and
communicating, with the UE, the subset of the set of radio resource management signals.
